(19) United States
(12) Patent Application Publication
(10) Pub. No.: US 2026/0187916 A1
(43) Pub. Date: Jul. 2, 2026

(54) GENERATIVE MODELING WITH TOPOLOGICAL CONTROL

(71) Applicant: INTERNATIONAL BUSINESS MACHINES CORPORATION, ARMONK, NY (US)

(72) Inventors: Soham Mukherjee, Milpitas, CA (US); Karthikeyan Natesan Ramamurthy, Pleasantville, NY (US); Payel Das, YORKTOWN HEIGHTS, NY (US)

(21) Appl. No.: 19/008,012

(22) Filed: Jan. 2, 2025

(51) Int. Cl. G06T 17/00

(52) U.S. Cl. CPC G06T 17/00; G06T 2211/441

(57) ABSTRACT

A method for generating new structures having a multi-dimensional topology comprises: receiving, by a generative model, a set of training data; generating a controllable topological skeleton from the set of training data; training the generative model with a combination of the set of training data and the controllable topological skeleton as a condition; and generating a new structure using the trained generative model enforced by at least one topological constraint established by a new condition.

### FIELD OF INVENTION

The present invention relates to methods and systems for training generative models utilizing topological skeletons. More particularly, the invention pertains to the training or adaptation of generative models to ensure that the structures produced by such models adheres to predefined underlying topological structures, wherein said structures are configurable and modifiable with ease.

### BACKGROUND

Embodiments of the present invention relate generally to computer-aided modeling of object geometries derived from large scale data sets, and more particularly to topology-aware generative modeling of three dimensional (3D) geometries.

### SUMMARY

Embodiments of the present invention provide a method, a computer program product, and a computer system for generating new structures having a multi-dimensional topology, comprising: receiving, by a generative model, a set of training data; generating a controllable topological skeleton from the set of training data; training the generative model with a combination of the set of training data and the controllable topological skeleton as a condition; and generating a new structure using the trained generative model enforced by at least one topological constraint established by a new condition.

Other embodiments of the present invention provide a method, a computer program product, and a computer system for generating new structures having a three dimensional topology, comprising: training, by a training subsystem, a generative model with a combination of the set of training data and a controllable topological skeleton; and generating, by a controllable structure generation subsystem, a new structure using the trained generative model enforced by at least one topological constraint.

### BRIEF DESCRIPTION OF THE DRAWINGS

FIG. 1 depicts a computing environment which contains an example of an environment for the execution of at least some of the computer code involved in performing one or more of the inventive methods, tools, and modules in accordance with embodiments of the present invention.

FIG. 2 is a block diagram of a system for generating new structures having an underlying topological structure that can be controllably modified, in accordance with some embodiments.

FIG. 3 is a flow diagram of a method for generating a topology-aware structure, in accordance with some embodiments.

FIG. 4 illustrates an image of a persistence diagram computed on a skeleton of data computer-generated object.

FIG. 5 is a graph of birth-death pairs obtained in by a persistent homology analysis, in accordance with some embodiments.

### DETAILED DESCRIPTION

There is an enormous amount of information in the modern world that is stored as large-scale data sets for retrieval by users for analysis and visualization. The emergence of artificial intelligence (AI) has resulted in the development of machine-learning (ML) algorithms and deep-neural networks (DNNs) to retrieve, analyze, and understand this vast amount of stored data. One promising area is generative AI, which is a subset of deep learning that focuses on building systems that can generate new data, such as images, videos, and audio. Generative AI uses techniques such as Generative Adversarial Networks (GANs) and Variational Autoencoders (VAEs) to create new data by learning from existing data. To train a generative model, a large amount of data, which may include images, text, sounds, etc. is collected from a domain and then the model is trained to generate the new data of interest.

However, in the conventional deep generative model, it has been difficult to control the data to be generated so that the core topology or encoding of the overall shape of data cannot be changed, resulting in the generation of data undesirable to a user. For example, controllability in the generation of protein configurations is crucial because generated configurations must be biologically plausible and must satisfy stability, energetic constraints. Furthermore, enhanced controllability facilitates generating proteins that can bind to a target site or catalyze a specific reaction. Conventional approaches offer some controllability of the generation of structures that is not interpretable, meaning the user has to find ad-hoc ways to tune the generated structures.

In brief overview, embodiments of the present inventive concept provide controllability of the topological skeleton so that it is interpretable. For example, if a user modifies the topological skeleton by adding, removing, or reshaping specific features, the generative model will produce structures that reflect these changes while preserving the overall consistency and plausibility of the design. This approach allows users to understand and predict the impact of their modifications eliminating the trial-and-error methods often required with conventional models. To achieve this, topology-aware generative modeling and techniques are provided that offer control by incorporating topology into generative models to improve the topological accuracy of generated images, shapes, or other outputs, for example, allowing the modification of the skeleton of a generated structure directly as distinguished from conventional topology-aware methods which lack such controllability. Improved control over generative models is offered. For example, if a user modifies the topological skeleton by adding, removing, or reshaping specific features, the generative model will produce structures that reflect these changes while preserving the overall consistency and plausibility of the design. This approach allows users to understand and predict the impact of their modifications eliminating the trial-and-error methods often required with conventional models.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlaps in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

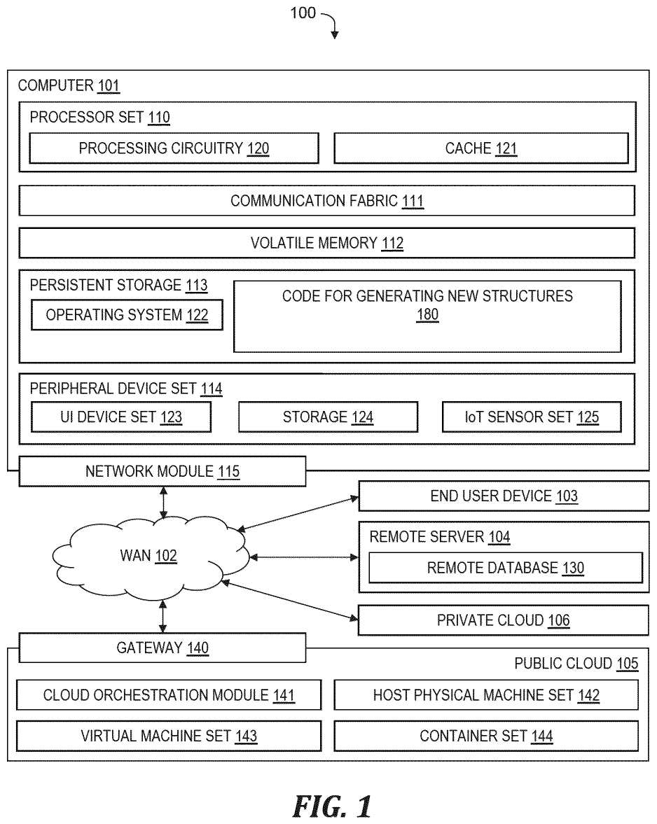

FIG. 1 is a block diagram of a computing environment 100, in accordance with embodiments of the present invention.

Computing environment 100 contains an example of an environment for the execution of at least some of the computer code involved in performing the inventive methods, such as code 180 for generating new structures within a topological data analysis (TDA) where the new structures obey topological constraints. The aforementioned computer code is also referred to herein as computer-readable code, computer-readable program code, and machine readable code. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified herein), peripheral device set 114 (including user interface (UI) device set 123, storage 124, and Internet of Things (IoT) sensor set 125), and network module 215. Remote server 104 includes remote database 130. Public cloud 105 includes gateway 140, cloud orchestration module 241, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing embodiments of the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 215 is the collection of computer software, hardware, and firmware that allows computer 101 to communicate with other computers through WAN 102. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer-readable program instructions for performing the inventive methods can typically be downloaded to computer 101 from an external computer or external storage device through a network adapter card or network interface included in network module 215.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 215 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 241. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

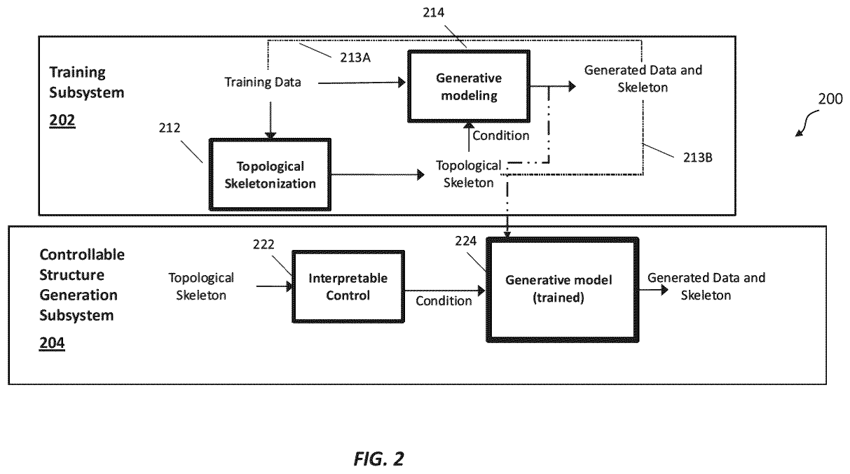

FIG. 2 is a block diagram of a system 200 for generating new structures, in accordance with some embodiments. In some embodiments, the system 200 includes a training subsystem 202 and a controllable structure generation subsystem 204, in accordance with embodiments of the present invention. Some or all of the system 200 can be implemented in the system 100 of FIG. 1, which provides components from a plurality of monitoring agents to an application backend system. For example, modules of the training subsystem 202 and a controllable structure generation subsystem 204 can be stored and processed at block 180 of FIG. 1.

In some embodiments, the training subsystem 202 includes a topological skeletonization module 212 and a generative modeling module 214. The topological skeletonization module 212 receives a set of training data, i.e., the same source of training data for training the generative model, and generates a skeleton-based representation, or topological skeleton. The topological skeleton can represent a reconstructed topologically complex surface of a 3D object, including shape topology and geometry, for example, 3D shape generation that accurately models complex topological and geometrical details. Dotted line 213A may represent a data loss function and dotted line 213B may represent a topological loss function that establishes the difference between the generative model's predictions and actual target values. The structure loss ensures that the generated data and training structure are similar. The skeleton loss ensures that the skeleton of the generated structure and the input skeleton are similar. As described herein, a feature of embodiments of the present inventive concept is that the skeleton can be a controllable skeleton, in that the skeleton of a generated structure can be modified directly. The topological skeleton serves as a representation of the shape and/or geometry of the 3D object because it can emphasize geometrical and topological properties of the shape, such as connections, topology, length, and distance to the shape boundary, and other information necessary to reconstruct the shape.

The generative modeling module 214 is used by a training process to generate a generative model from the topological skeleton output from the topological skeletonization module 212 applied to a set of training data. The generative model created by the training process can be provided to the trained generative model 224 of the controllable structure generation subsystem 204.

The training subsystem 202 iteratively changes parameters of the model to improve the match with the received topological skeleton data. During training, the generative model iteratively generates and keeps refining the structures. The dotted lines indicate that the generated structures are compared to the training data as well as its skeleton. If the error between them is too large, then the generative model will continue to modify the parameters, for example, for optimization, until the error (if any) is reduced to a value that is less than a predetermined threshold, or zero.

The generation subsystem 204 is constructed to receive and process a trained model with topological control and use it to actually create new structures, i.e., structures whose underlying topological skeleton is computed. In other words, after the model in the training subsystem 202 is fully trained, it can be used to generate new structures, for example, for the generation subsystem 204. The generation subsystem 204 is constructed and arranged to generate controllable topology-aware skeleton structures, i.e., new structures whose underlying topological structure can be controllably modified. For example, a skeleton of a structure generated by the training subsystem 202 can be modified by the generation subsystem 204. The new structures can be used as training data to train a new generative model by the generative modeling module 214 of the training subsystem 202.

In some embodiments, the generation subsystem 204 comprises an interpretable control module 222 and a trained generative model 224. The trained generative model 224 can generate modified topology-aware structures, and in doing so relies on the generative modeling module 214. The trained generative model 224 also be used to generate a structure and takes as input a topological skeleton, for example, a Reeb skeleton generated by the topological skeletonization module 212, distinguished from the topological skeleton input into the interpretable control 222. The skeleton input to the trained generative model 224 can therefore be created in any manner including using the skeletonization module 212. The interpretable control module 222 can provide conditions to the trained generative model 224. For example, a skeleton may state that a molecule requires two holes. The skeleton can be controlled by the control module 222 to change the size of the holes, etc. As described herein, the topological constraints of the underlying structure are topological summaries of the intended target and are enforced by the loss functions 213. In some embodiments, the constraints are topological summaries of the modified skeletonized target configuration, or output structure output from the trained model adhering to the user configured input, which can be compared to the target of interest, e.g., a new three dimensional structure.

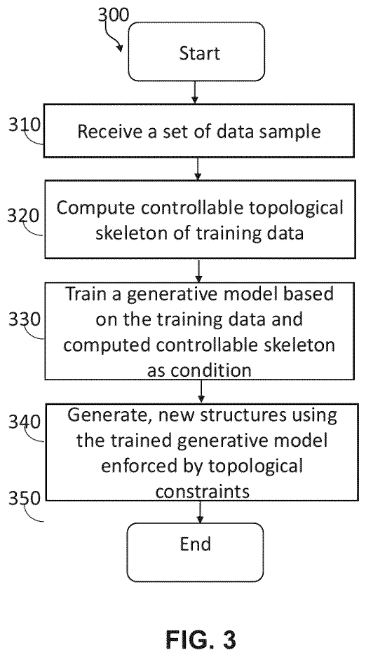

FIG. 3 is a flow diagram of a method 300 for generating a topology-aware structure, in accordance with some embodiments. In describing the method 300, reference is made to the system 200 of FIG. 2.

At step 310, a training process is executed for a generative model. Here, target data is collected for generating a topological skeleton, or skeleton-based representation encoding information on shape topology and geometry of a structure of interest. In some embodiments, the target data is provided by the training subsystem 202. In other embodiments, the target data is provided. For example, the data may include known molecular data used for discovering new molecules, or molecules having a unique structure or other features. In doing so, the generative model is trained to learn the basic structure of molecules. Other data may be received from data sources pertaining to application domains where predictions affect humans, such as drug discovery, healthcare, material science, and so on, where drug or protein molecule generation and new material discovery are desired.

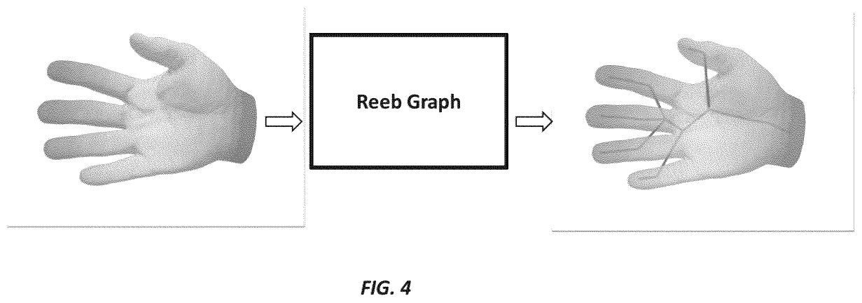

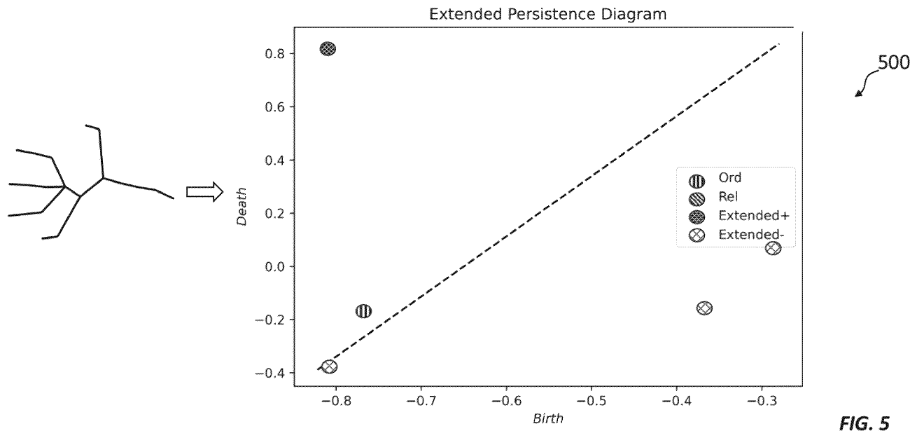

The training data for training the generative model is also used for a topological skeletonization process. At step 320, a controllable topological skeleton created from the training data is used to the train generative model. In some embodiments, a persistence diagram is computed on the extracted skeleton generated at the generative modeling module 214 to provide control, shown and described in greater detail with respect to FIG. 4A-5. Here, topological features of the Reeb skeleton are summarized. More specifically, when computing the persistence diagram, topologically relevant features such as birth-death coordinate pairs of a Reeb graph are summarized through persistent homology (see FIG. 5). A Reeb graph can provide symbolic and skeletal representations of manifolds that provide an overview of the shape structure. In FIGS. 4B and 4C, a Reeb graph is illustrated as a simplified, topological representation of a 3D shape, extracted by analyzing data for a function defined on the shape, and capturing the “backbone” of the object's topology through a graph structure, where nodes represent critical points and edges represent connections between those points based on how level sets change across the shape. As shown in FIG. 5, the persistence diagram 500 can be computed on the Reeb graph skeleton shown in FIG. 4. In some embodiments, topological descriptors are summarized by being employed in machine learning tasks using summary statistics, such as persistence values of the generated persistence diagram. Such statistics may entail hypothesis testing based on the topological information when performing data analysis. It is desired to ensure that the generated Reeb graph closely resembles the target Reeb graph. However, directly comparing and aligning two Reeb graphs is a complex task. Persistence diagrams offer a more practical alternative, as they provide a quantifiable and straightforward way to enforce similarity through loss functions. A persistence diagram can summarize the shape of data by identifying its topological features, such as clusters, holes, or voids, and can be used to record when these features appear and disappear as the data is analyzed at different scales. Therefore, using persistence diagrams is essential for achieving this control.

For example, as shown in FIG. 5, the persistence diagram 500 can store topological changes across a whole range of scales information determined from persistent homology, and show each topological feature's time of birth (x-coordinate) and death (y-coordinate) with a point in the XY-plane. The dots represent different topological features, and more specifically, denote birth-death pairs of features above the line of y=x, the features being of a Reeb graph or the like through persistent homology. Persistence images can be obtained from the persistence diagram 500. Larger features may appear farther from the diagonal line, while small, short-lived features are closer to it. Thus, the persistence diagram 500 provides a summary, focusing on the most significant features and ignoring minor, noisy ones, which is useful for understanding complex shapes and patterns in data.

Referring again to FIG. 3, the persistence diagram 500 can be applied to the topological skeleton, more specifically, the skeleton output from the topological skeletonization module 212, which can be applied to the generative model 214 is a condition, or constraint.

During generation of new structures, at step 330, a controllable skeleton of a generated structure can be created from the generative model trained at step 330.

At step 340, the controllable skeleton created in step 330 can be adjusted as necessary, or topological controls over data that can be produced at the subsystem 204.

At step 350, a new structure can be conditionally generated from the controllable skeleton.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating new structures having a multi-dimensional topology, comprising:
receiving, by a generative model, a set of training data;
generating a controllable topological skeleton from the set of training data;
training the generative model with a combination of the set of training data and the controllable topological skeleton as a condition; and
generating a new structure using the trained generative model enforced by at least one topological constraint established by a new condition.

2. The computer-implemented method of claim 1, further comprising:
forming a first loss function for a topological loss between the topological skeleton and generated data at an output of the generative model to establish that the topological skeleton and a skeleton of the new structure are within a predetermined threshold; and
forming a second loss function for a data loss between the training data and the generated data to establish that the training data for the new structure and the generated data are within a predetermined threshold.

3. The computer-implemented method of claim 2, further comprising generating a persistence diagram of the controllable topological skeleton.

4. The computer-implemented method of claim 3, wherein the persistence diagram is computed on a Reeb graph skeleton.

5. The computer-implemented method of claim 1, further comprising:
identifying a plurality of topological constraints from a control module to the trained generative model; and
computing the controllable topological skeleton to comply with the plurality of topological constraints.

6. The computer-implemented method of claim 5, further comprising:
generating additional new structures that are derivations of the controllable skeleton, wherein each of the additional new structures comply with the plurality of topological constraints.

7. The computer-implemented method of claim 5, wherein the topological constraints include topological summaries of a modified skeletonized target configuration.

8. The computer-implemented method of claim 1, wherein identifying the plurality of topological constraints includes receiving user configured input.

9. The computer-implemented method of claim 1, further comprising using the new structures as training data to train a new generative model.

10. The computer-implemented method of claim 1, further comprising:
applying a training process to a generate the generative model from the topological skeleton applied to a set of training data.

11. A computer-implemented method for generating new structures having a multi-dimensional topology, comprising:
training, by a training subsystem, a generative model with a combination of the set of training data and a controllable topological skeleton; and
generating, by a controllable structure generation subsystem, a new structure using the trained generative model enforced by at least one topological constraint.

12. The computer-implemented method of claim 11, further comprising:
forming a first loss function for a topological loss between the controllable topological skeleton and generated data at an output of the generative model to establish that the topological skeleton and a skeleton of the new structure are within a predetermined threshold; and
forming a second loss function for a data loss between the training data and the generated data to establish that the training data for the new structure and the generated data are within a predetermined threshold.

13. The computer-implemented method of claim 11, further comprising generating a persistence diagram of the controllable topological skeleton.

14. The computer-implemented method of claim 13, wherein the persistence diagram is computed on a Reeb graph skeleton.

15. The computer-implemented method of claim 11, further comprising:
computing the controllable topological skeleton to comply with the at least one topological constraint.

16. The computer-implemented method of claim 11, further comprising:
generating additional new structures that are derivations of the controllable skeleton, wherein each of the additional new structures comply with the plurality of topological constraints.

17. A computer program product, comprising one or more computer readable hardware storage devices having computer readable program code stored therein, said program code containing instructions executable by one or more processors of a computer system to implement a method for generating new structures having a three dimensional topology, said method comprising the steps of:
generating new structures having a three dimensional topology, comprising:
receiving, by a generative model, a set of training data;
generating a controllable topological skeleton from the set of training data;
training the generative model with a combination of the set of training data and the controllable topological skeleton as a condition; and
generating a new structure using the trained generative model enforced by at least one topological constraint established by a new condition.

18. The computer program product of claim 17, further comprising:
forming a first loss function for a topological loss between the topological skeleton and generated data at an output of the generative model to establish that the topological skeleton and a skeleton of the new structure are within a predetermined threshold; and
forming a second loss function for a data loss between the training data and the generated data to establish that the training data for the new structure and the generated data are within a predetermined threshold.

19. The computer program product of claim 17, further comprising generating a persistence diagram of the controllable topological skeleton.

20. The computer program product of claim 17, further comprising:
generating additional new structures that are derivations of the controllable skeleton, wherein each of the additional new structures comply with the plurality of topological constraints.
